(19) United States
(12) Patent Application Publication
(10) Pub. No.: US 2012/0181404 A1
(43) Pub. Date: Jul. 19, 2012

(54) THIN-SHEET METAL MEMBER MOUNTING STRUCTURE

(76) Inventor: Chin-Hsing Horng, Kueishan Hsiang (TW)

(21) Appl. No.: 13/006,416

(22) Filed: Jan. 13, 2011

(51) Int. Cl. F16M 13/00

(52) U.S. Cl. 248/309.1

(57) ABSTRACT

A thin-sheet metal member mounting structure includes a body member having retaining grooves spaced around the periphery thereof, and a cover member made of a metal material comprising a base portion attached to the top wall of the body member, a wing portion extending from the border of the base portion at a predetermined angle and attached to the periphery of the body member and a plurality of male fastening devices protruded from and formed of a part of the inside wall of the wing portion remote from the base portion by means of a cutting technique and respectively forced into engagement with the retaining grooves of the body member.

### BACKGROUND OF THE INVENTION

1. Field of the Invention

The present invention relates to a metal member mounting technology and more particularly, to a thin-sheet metal member mounting structure, which facilitates mounting of a metal cover member on a body member while keeping the outer surface of the metal cover member intact and smooth.

2. Description of the Related Art

It is the market trend to make mobile electronic devices (such as cell phone, notebook computer, PDA, etc.) having light, thin, short and small characteristics convenient for carrying. In order to reduce the weight while maintaining a shinning outer look and high torsional strength, a thin-sheet metal cover member may be used and covered on a plastic body member. The metal cover member protects the product and facilitates surface treatment, such as electroplating or spray-painting.

Conventionally, fastening a thin-sheet metal cover member to a body member is achieved by means of the application of an adhesive. This mounting technique has drawbacks as follows:

1. When the adhesive is hardened, its volume will be contracted, causing presence of crevices in between the metal cover member and the body member.

2. The application of an adhesive increases the cost. Further, it is necessary to wait for the hardening of the applied adhesive before starting a next processing step.

Spot welding or riveting techniques may be employed to fasten a metal cover member to a body member. However, these methods will destroy the outer appearance of the metal cover member. To avoid surface damage, the thickness of the metal cover member must be relatively increased.

### SUMMARY OF THE INVENTION

The present invention has been accomplished under the circumstances in view. It is the main object of the present invention to provide a thin-sheet metal member mounting structure, which enables a metal cover member to be fixedly fastened to a body member without the use of an adhesive or any external fastening means, thereby keeping the outer surface of the metal cover member intact and smooth.

To achieve this and other objects of the present invention, a thin-sheet metal member mounting structure includes a body member having retaining grooves spaced around the periphery thereof, and a cover member made of a metal material comprising a base portion attached to the top wall of the body member, a wing portion extending from the border of the base portion at a predetermined angle and attached to the periphery of the body member and a plurality of male fastening devices protruded from and formed of a part of the inside wall of the wing portion remote from the base portion by means of a cutting technique and respectively forced into engagement with the retaining grooves of the body member.

Further, each male fastening device comprises a fastening strip obliquely outwardly curved from the inside wall of said wing portion. The fastening strip has one end thereof connected to the inside wall of the wing portion, an opposite end thereof obliquely extending in direction toward the base portion and terminating in a stop edge for stopping against a stop edge in the associating retaining groove of the body member. Further, side ribs may be simultaneously formed of a part of the inside wall of the wing portion and bilaterally connected between the fastening strip and the wing portion when cutting the inside wall of the wing portion to form the fastening strip.

### BRIEF DESCRIPTION OF THE DRAWINGS

FIG. 1 is a sectional view of a thin-sheet metal member mounting structure in accordance with a first embodiment of the present invention.

FIG. 2 is a sectional exploded view of the thin-sheet metal member mounting structure in accordance with the first embodiment of the present invention,

FIG. 3 is an elevational view of a part of the first embodiment of the present invention, illustrating the structure of each male fastening device.

FIG. 4 is a sectional side view of FIG. 3.

FIG. 5 is an enlarged view of a part of FIG. 2.

FIG. 6 corresponds to FIG. 5, illustrating the male fastening device engaged with the associating female fastening device.

FIG. 7 is an elevational view of a part of a thin-sheet metal member mounting structure in accordance with a second embodiment of the present invention.

FIG. 8 is a sectional side view of FIG. 7.

FIG. 9 corresponding to FIG. 8, illustrating the side ribs trimmed.

FIG. 10 is a schematic sectional view of a part of the second embodiment of the present invention, illustrating the male fastening device engaged with the associating female fastening device.

FIG. 11 is an elevational view of a part of a thin-sheet metal member mounting structure in accordance with a third embodiment of the present invention.

FIG. 12 is a sectional exploded view of the thin-sheet metal member mounting structure in accordance with the third embodiment of the present invention.

FIG. 13 is a schematic sectional view of a part of the third embodiment of the present invention, illustrating the male fastening device engaged with the associating female fastening device.

FIG. 14 is an elevational view of a part of a thin-sheet metal member mounting structure in accordance with a fourth embodiment of the present invention.

FIG. 15 is a schematic sectional view of a part of the fourth embodiment of the present invention, illustrating the male fastening device engaged with the associating female fastening device.

### DETAILED DESCRIPTION OF THE PREFERRED EMBODIMENT

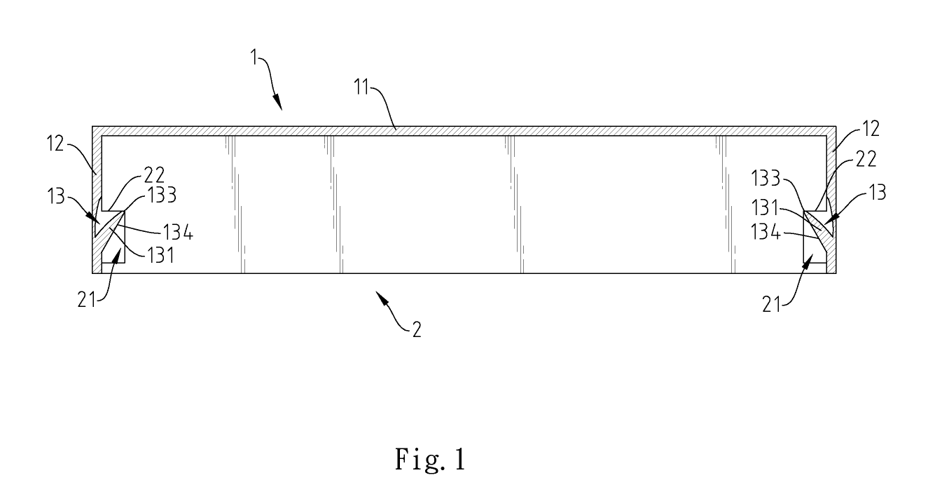

Referring to FIGS. 1˜4, a thin-sheet metal member mounting structure in accordance with a first embodiment of the present invention is shown comprising a cover member 1 and a body member 2.

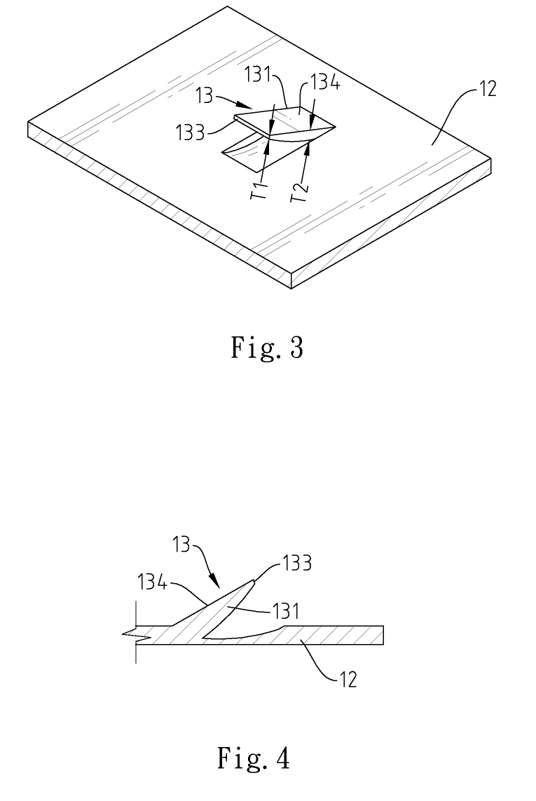

The cover member 1 is made of a thin metal sheet, comprising a base portion 11, a wing portion 12 extending from the border of the base portion 11 at a predetermined angle, for example, 90° angle, and a plurality of male fastening devices 13 located on the inner surface near the distal end of the wing portion 12 at selected locations remote from the base portion 11. As illustrated in FIG. 3 and FIG. 4, each male fastening device 13 comprises a fastening strip 131 obliquely outwardly curved from one side of the wing portion 12. The fastening strip 131 is formed by means of cutting the selected side of the wing portion 12 with a machine tool, having one end thereof connected to the surface of the wing portion 12, an opposite end thereof obliquely extending in direction toward the base portion 11 and terminating in a stop edge 133 and an oblique guide face 134 located on one side thereof remote from the wing portion 12. The thickness T1 of the distal end of the fastening strip 131 is smaller than the thickness T2 of the junction between the fastening strip 131 and the wing portion 12.

The body member 2 comprises a plurality of female fastening devices 21 for engagement with the male fastening devices 13 of the cover member 1. The female fastening devices 21 are retaining grooves located on the periphery of the body member 2, each comprising a stop edge 22 located on the top side thereof and spaced from the top wall of the body member 2 at a predetermined distance L2 that is equal to the distance L1 between the stop edge 133 of each male fastening device 13 of the cover member 1 and the bottom wall of the base portion 11.

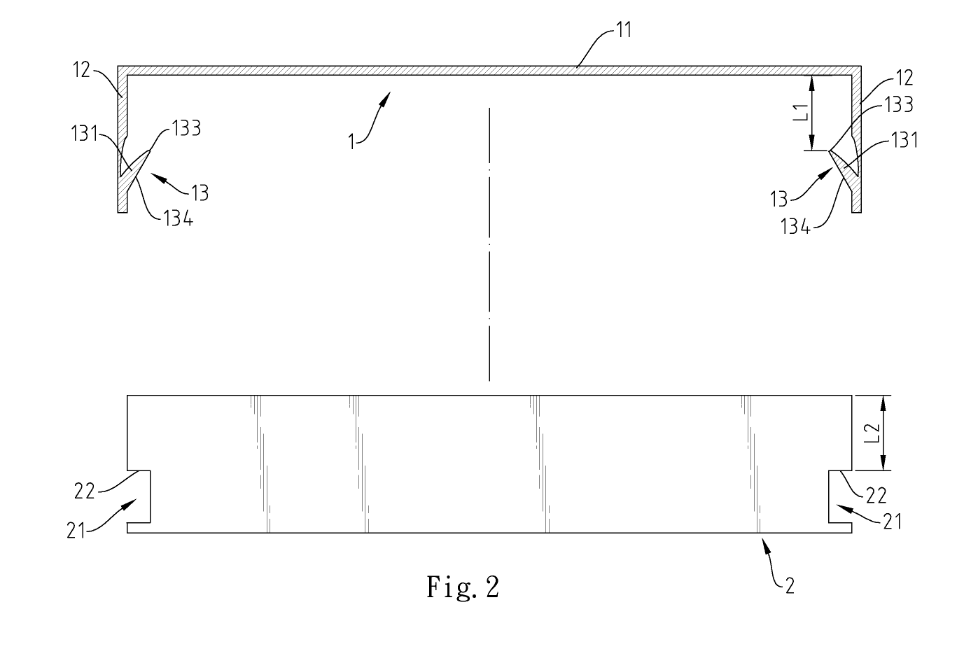

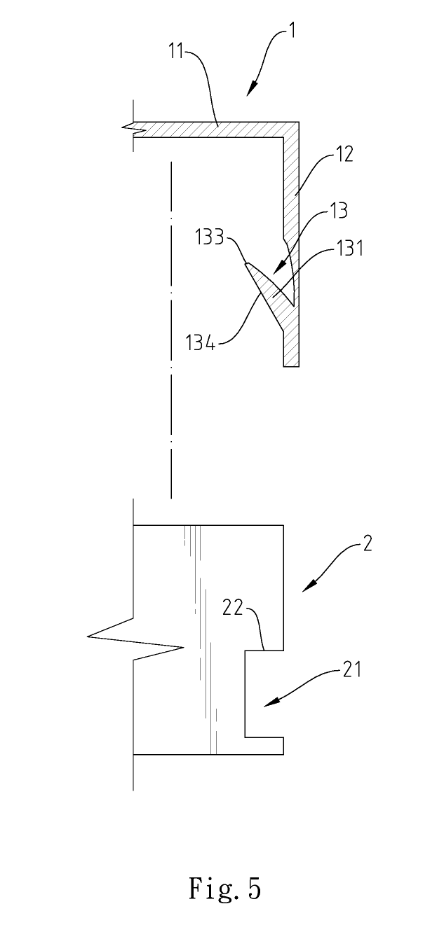

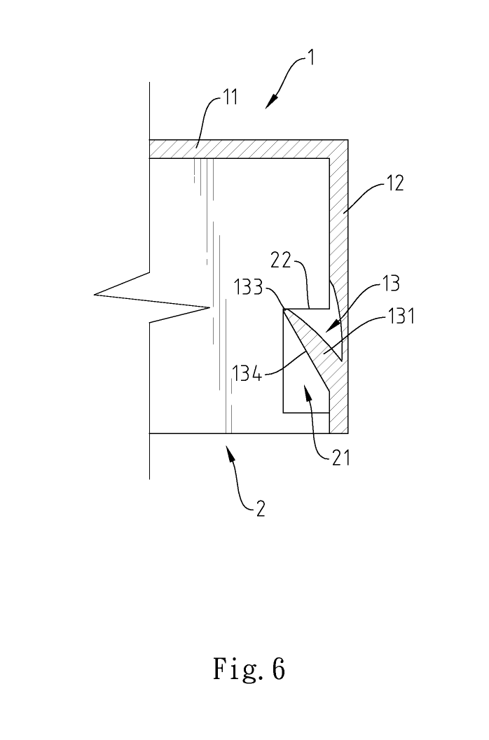

Referring to FIGS. 5 and 6 and FIGS. 1-4 again, when covering the cover member 1 on the top side of the body member 2, the fastening strips 131 of the male fastening devices 13 of the cover member 1 will be compressed by and moved along the periphery of the body member 2 and then forced into engagement with the female fastening devices (retaining grooves) 21 of the body member 2 respectively to have the bottom wall of the base portion 11 of the cover member 1 be attached to the top wall of the body member 2 and the bottom wall of the wing portion 12 be closely attached to the periphery of the body member 2. When the cover member 1 is lowered relative to the body member 2 to the elevation where the male fastening devices 13 of the cover member 1 are respectively aimed at the female fastening devices (retaining grooves) 21 of the body member 2, the fastening strips 131 of the male fastening devices 13 of the cover member 1 will immediately return to their former position and engage into the female fastening devices (retaining grooves) 21 of the body member 2. Because the distance L1 between the stop edge 133 of each male fastening device 13 of the cover member 1 and the bottom wall of the base portion 11 is equal to the distance L2 between the stop edge 22 of each female fastening device (retaining groove) 21 and the top wall of the body member 2, the stop edge 133 of each male fastening device 13 of the cover member 1 will be stopped against the stop edge 22 of the associating female fastening device (retaining groove) 21 when the fastening strips 131 of the male fastening devices 13 of the cover member 1 are respectively engaged into the female fastening devices (retaining grooves) 21 of the body member 2, enhancing the connection tightness. Further, subject to the design of the oblique guide face 134, each fastening device 13 of the cover member 1 can be smoothly moved along the periphery of the body member 2 and then forced into the associating female fastening device (retaining groove) 21.

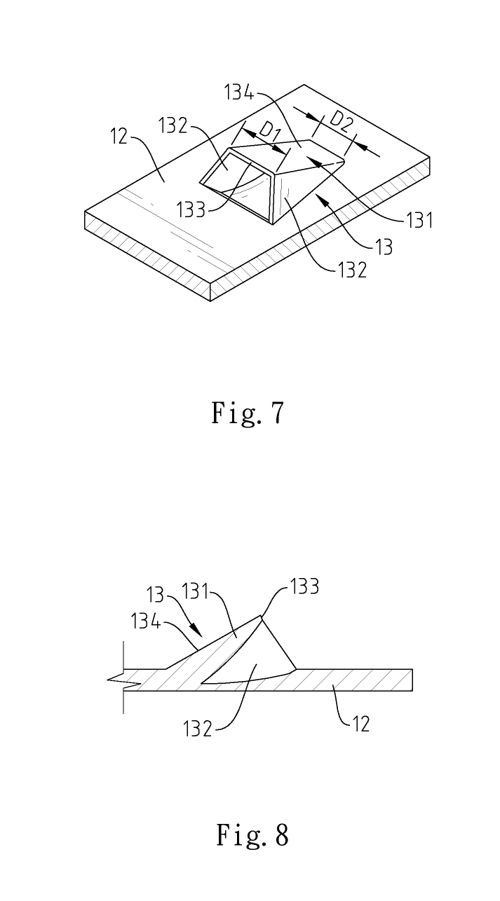

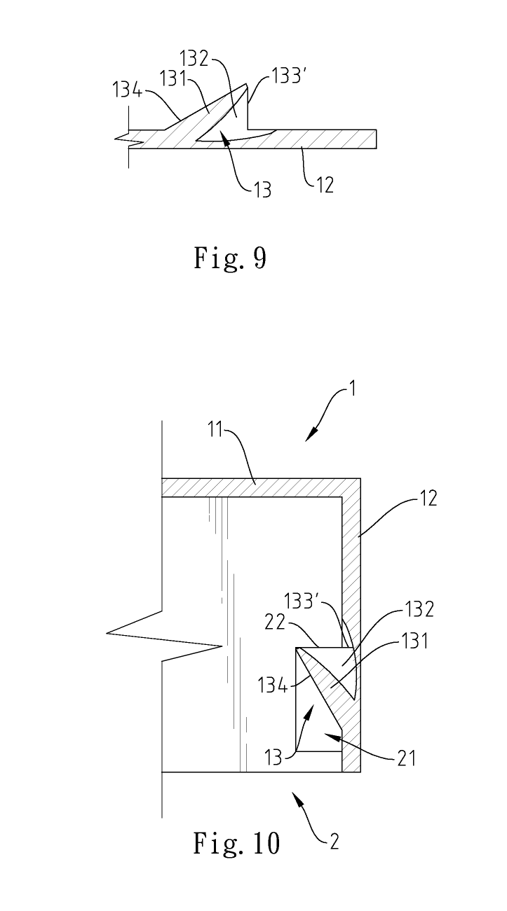

FIGS. 7˜10 illustrate a thin-sheet metal member mounting structure in accordance with a second embodiment of the present invention. This second embodiment is substantially similar to the aforesaid first embodiment with the exception of the design of the fastening devices 13. According to this second embodiment, each fastening device 13 further comprises two side ribs 132 respectively obliquely connected between two opposite lateral sides of the fastening strip 131 and the wing portion 12. Further, each side rib 132 is trimmed to provide a stop edge 133′ that is kept in flush with the top edge 133 of the fastening strip 131. The fastening devices 13 are formed of a part of the wing portion 12 by means of a cutting technique. As the method of making the fastening devices 13 is of the known art and not within the scope of the spirit of the present invention, no further detailed description in this regard is necessary. When covering the cover member 1 on the body member 2, the male fastening devices 13 of the cover member 1 will be respectively forced into engagement with the female fastening devices (retaining grooves) 21 of the body member 2, and the stop edges 133; 133′ of the male fastening devices 13 will be stopped against the stop edges 22 of the female fastening devices (retaining grooves) 21 respectively. Further, as illustrated in FIG. 7, the width D1 of the distal end of the fastening strip 131 is greater than the width of the junction between the fastening strip 131 and the wing portion 12.

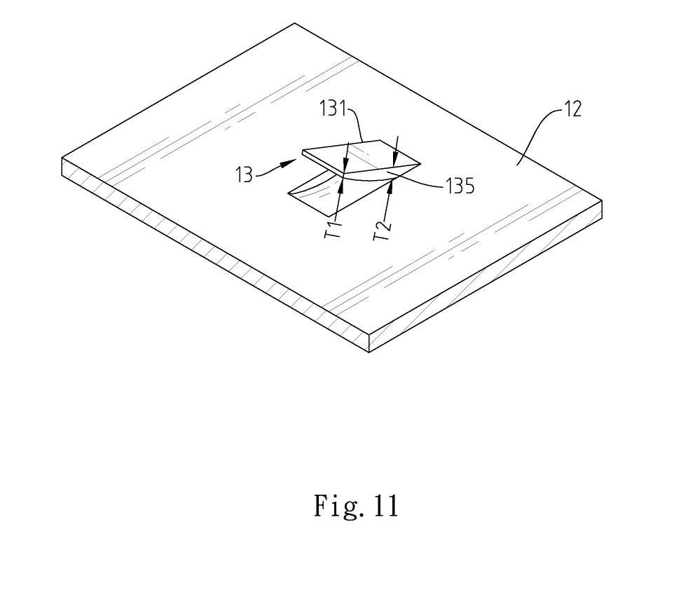

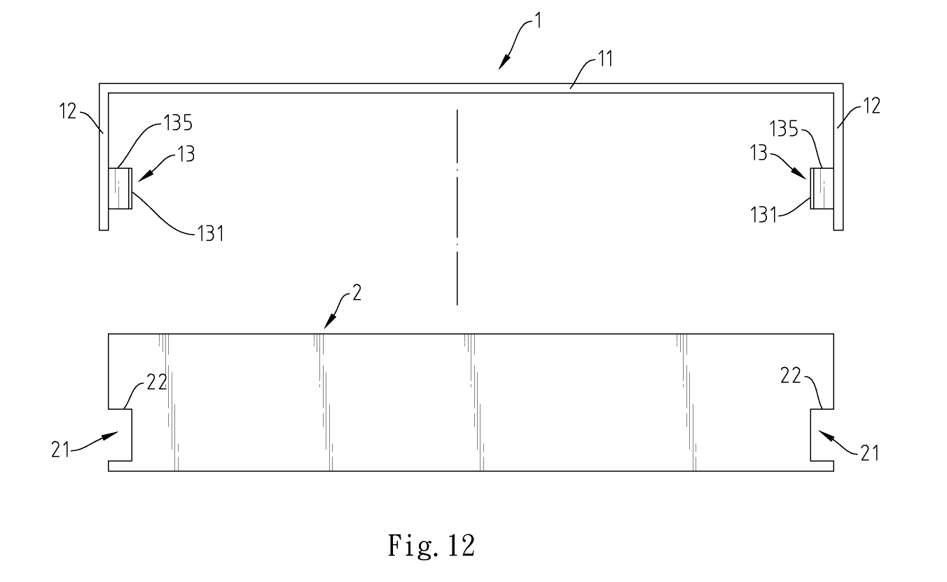

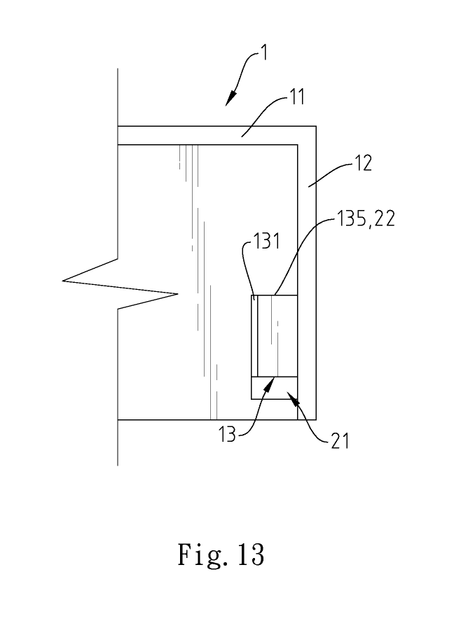

FIGS. 11˜13 illustrate a thin-sheet metal member mounting structure in accordance with a third embodiment of the present invention. According to this third embodiment, the thin-sheet metal member mounting structure comprises a cover member 1 and a body member 2. The cover member 1 is made of a thin metal sheet, comprising a base portion 11, a wing portion 12 extending from the border of the base portion 11 at a predetermined angle, and a plurality of male fastening devices 13 located on the inner surface of the wing portion 12 at selected locations remote from the base portion 11. As illustrated in FIG. 1 and FIG. 12, each male fastening device 13 comprises a fastening strip 131 formed of a part of the wing portion 12 by means of a cutting technique. The fastening strip 131 has its one end connected to the wing portion 12 and its other end extending in a parallel manner relative to the base portion 11, and defines a stop edge 135 at its one side near the base portion 11. The thickness T1 of the distal end of the fastening strip 131 is smaller than the thickness T2 of the junction between the fastening strip 131 and the wing portion 12. The body member 2 comprises a plurality of female fastening devices 21 for engagement with the male fastening devices 13 of the cover member 1. The female fastening devices 21 are retaining grooves located on the periphery of the body member 2, each comprising a stop edge 22 for stopping against the stop edge 135 of the associating male fastening device 13. When covering the cover member 1 on the body member 2, the fastening strips 131 of the male fastening devices 13 of the cover member 1 will be compressed by and moved along the periphery of the body member 2 and then forced into engagement with the female fastening devices (retaining grooves) 21 of the body member 2 respectively to have the bottom wall of the base portion 11 of the cover member 1 be attached to the top wall of the body member 2 and the bottom wall of the wing portion 12 be closely attached to the periphery of the body member 2 and the stop edges 135 of the male fastening devices 13 of the cover member 1 be stopped the stop edges 22 of the female fastening devices (retaining grooves) 21 of the body member 2 respectively.

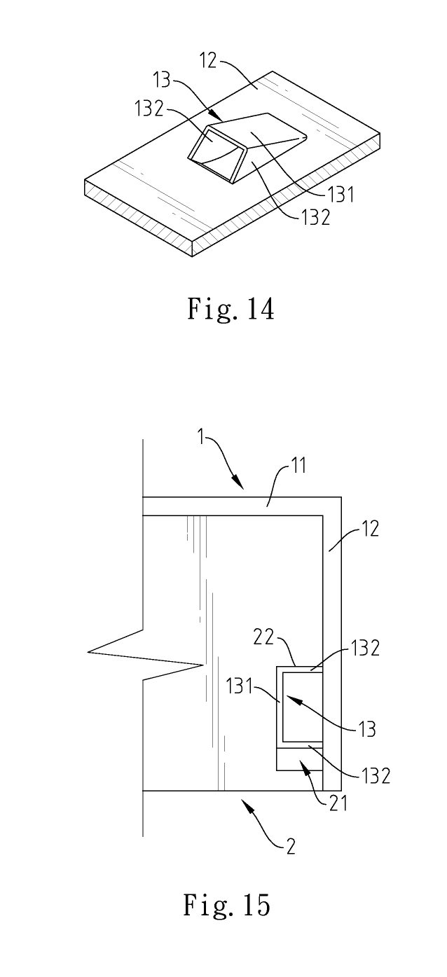

FIGS. 14 and 15 illustrate a thin-sheet metal member mounting structure in accordance with a fourth embodiment of the present invention. This second embodiment is substantially similar to the aforesaid second embodiment with the exception of the design of the fastening devices 13 with the exception that the two side ribs 132 of each fastening devices 13 according to this fourth embodiment is kept in parallel. When covering the cover member 1 on the body member 2, the male fastening devices 13 of the cover member 1 will be respectively forced into engagement with the female fastening devices (retaining grooves) 21 of the body member 2, enhancing the connection tightness.

In conclusion, the invention provides a thin-sheet metal member mounting structure, which has the advantages and features as follows:

1. The cover member 1 comprises a plurality of male fastening devices 13 formed integral with the wing portion 12 thereof, each fastening device 13 comprising a fastening strip 131 formed of a part of the wing portion 12 by means of a cutting technique. When covering the cover member 1 on the body member 2, the fastening strip 131 of each male fastening device 13 of the cover member 1 will be respectively forced into engagement with one respective female fastening device (retaining groove) 21 of the body member 2, enhancing the connection tightness. As each male fastening device 13 is formed of a part of the inside wall of the wing portion 12 of the cover member 1, the outer surface of the cover member 1 is kept intact and smooth.

2. The thickness T1 of the distal end of the fastening strip 131 of each fastening device 13 is smaller than the thickness T2 of the junction between the respective fastening strip 131 and the wing portion 12, and therefore the fastening strip 131 of each fastening device 13 has a high tensile strength, avoiding permanent deformation and assuring connection tightness between the cover member 1 and the body member 2.

3. When cutting the inside wall of the wing portion 12 to form each fastening device 13, two side ribs 132 can be simultaneously formed and respectively connected between two opposite lateral sides of the fastening strip 131 and the wing portion 12 to enhance the strength of the fastening strip 131, assuring connection tightness between the cover member 1 and the body member 2.

Although particular embodiments of the invention have been described in detail for purposes of illustration, various modifications and enhancements may be made without departing from the spirit and scope of the invention.

What the invention claimed is:

1. A thin-sheet metal member mounting structure, comprising a body member, and a cover member capped on said body member, wherein:
said body member comprises a top wall, a peripheral wall extending from said top wall at a predetermined angle and a plurality of retaining grooves spaced around said peripheral wall;
said cover member is made of a metal material comprising a base portion attached to the top wall of said body member, a wing portion extending from the border of said base portion at a predetermined angle and attached to the peripheral wall of said body member, and a plurality of male fastening devices located on an inside wall of said wing portion near a distal end thereof remote from said base portion and respectively forced into engagement with said retaining grooves of said body member, each said male fastening device being formed of a part of the inside wall of said wing portion by means of a cutting technique.

2. The thin-sheet metal member mounting structure as claimed in claim 1, wherein each said male fastening device comprises a fastening strip obliquely outwardly curved from the inside wall of said wing portion, said fastening strip having one end thereof connected to the inside wall of said wing portion, an opposite end thereof obliquely extending in direction toward said base portion and terminating in a stop edge for stopping against a stop edge in the associating retaining groove of said body member and an oblique guide face located on one side thereof remote from said wing portion.

3. The thin-sheet metal member mounting structure as claimed in claim 2, wherein each said male fastening device further comprises two side ribs respectively obliquely connected between two opposite lateral sides of the respective fastening strip and the inside wall of said wing portion and formed integral with the inside wall of said wing portion.

4. The thin-sheet metal member mounting structure as claimed in claim 2, wherein each said male fastening device further comprises two side ribs respectively connected between two opposite lateral sides of the respective fastening strip and the inside wall of said wing portion in a parallel manner and formed integral with the inside wall of said wing portion, each said side rib having a distal end terminating in a stop edge for stopping against one respective stop edge in the associating retaining groove of said body member.

5. The thin-sheet metal member mounting structure as claimed in claim 2, wherein the thickness of the distal end of each said fastening strip is smaller than the thickness of the junction between the respective fastening strip and said wing portion.

6. The thin-sheet metal member mounting structure as claimed in claim 2, wherein the width of the distal end of each said fastening strip is smaller than the width of the junction between the respective fastening strip and said wing portion.

7. The thin-sheet metal member mounting structure as claimed in claim 1, wherein each said male fastening device comprises a fastening strip outwardly curved from the inside wall of said wing portion, said fastening strip having one end thereof connected to the inside wall of said wing portion, an opposite end thereof extending in a parallel manner relative to said base portion and a stop edge located on one lateral side thereof for stopping against a stop edge in the associating retaining groove of said body member.

8. The thin-sheet metal member mounting structure as claimed in claim 1, wherein each said male fastening device comprises a fastening strip obliquely outwardly curved from the inside wall of said wing portion, said fastening strip having one end thereof connected to the inside wall of said wing portion, an opposite end thereof extending in a parallel manner relative to said base portion, and two side ribs bilaterally connected between said fastening strip and said wing portion in a parallel manner, said fastening strip and said side ribs being formed of a part of the inside wall of said wing portion by means of a cutting technique.
